(19) United States
(12) Patent Application Publication
(10) Pub. No.: US 2014/0281211 A1
(43) Pub. Date: Sep. 18, 2014

(54) FAST MOUNT CACHE

(71) Applicant: Silicon Graphics International Corp., Milpita, CA (US)

(72) Inventors: Lance MacKimmie Evans, Boulder, CO (US); Kevan Flint Rehm, Brooklyn Park, MN (US); Phil Armstrong, Eagan, MN (US)

(73) Assignee: Silicon Graphics International Corp., Milpitas, CA (US)

(21) Appl. No.: 13/836,073

(22) Filed: Mar. 15, 2013

(51) Int. Cl. G06F 3/06

(52) U.S. Cl. CPC G06F 3/0647; G06F 3/0608; G06F 3/0685
USPC 711/111

(57) ABSTRACT

A fast mount cache is provided by any offline storage media for fast volume mount access. The fast mount cache may be used as the first level in a hierarchical storage configuration after the high performance tier for data having high access rates shortly after creation but decreases sharply as the data ages. The fast mount cache stores migrated data from online hard disk drive storage and maintains the data on a volume basis as opposed to a file basis. As the fast mount cache capacity fills, or other events occur triggering a volume change, the fast mount cache erases the volume having the oldest data. While data is maintained on the fast mount cache for periods of time soon after it is migrated, the data may be accessed quickly. After the initial period of time has expired, the data only exists on tape storage or low tier data.

### BACKGROUND OF THE INVENTION

1. Field of the Invention

The present invention relates to data storage systems. More specifically, the present invention relates to tiered storage systems that utilize MAID tiers.

2. Description of the Related Art

As companies create and store more and more data, there is an increasing need for improved data storage systems. Oftentimes, companies create data, store the data, utilize it for different periods of time, and then rarely access the data again. Sometimes, the period of time the data is accessed after it is created is within a short period of time only.

Tiered data storage systems are utilized by data centers to provide different levels of storage at different levels of speed and cost. Tiered data systems often provide a high tier storage level for data which can be accessed quickly. Though having a quick access time, the high data storage tier is expensive to maintain. Tiered systems also include a low tier data storage system. Low tier data storage is typically implemented with tape drives. Tape infrastructure is less expensive, but has very slow access times. Sometimes, accessing data from a tape drive can take hours or days.

What is needed is an improved method to access data other than a high tier storage and low tier storage.

### SUMMARY OF THE CLAIMED INVENTION

The present invention utilizes a fast mount cache provided by any offline storage medium for fast volume mount access. The fast mount cache may be used as the first level in a hierarchical storage configuration after the high performance tier for data having high access rates shortly after creation but decreasing sharply as the data ages. This provides the present system with very fast access to large amounts of data which is impractical to be maintained on online hard disk drives because of capacity issues.

When migrated from a high performance tier, the data is migrated to the fast mount cache and any other tier according to policies implemented by a data storage manager. The fast mount cache may store migrated data from online storage devices and maintains the data by volume. As the fast mount cache capacity fills, or other active or passive events trigger a volume change, the fast mount cache erases volumes according to the storage manager's policies. In this manner, the fast mount cache may create space by erasing volumes of data. While data is maintained on the fast mount cache for periods of time soon after it is migrated, the data may be accessed quickly. After the initial period of time has expired, or other storage policies eliminate fast mount cache volumes, the data only exists on tape or other low tier data storage.

An embodiment for managing data storage in a multitier data storage system begins with migrating data from a high performance data storage devices to MAID data storage and tape storage. An event may be detected which is associated with the MAID data storage. The oldest volume of data in the MAID data storage may be erased in response to the event.

### BRIEF DESCRIPTION OF THE DRAWINGS

FIG. 1 is a block diagram of a tiered data storage system.

FIG. 2 is a block diagram of a data storage manager.

FIG. 3 is a method for migrating data to a fast mount cache.

FIG. 4 is a method for retrieving data.

FIG. 5 is a block diagram of a computing device for use with the present invention.

### DETAILED DESCRIPTION

In embodiments, a fast mount cache provided by any offline storage media having fast volume mount access. The fast mount cache may be used as the first level in a hierarchical storage configuration after the high performance tier for data having high access rates shortly after creation but which decreases sharply as the data ages. This provides the present system with very fast access to large amounts of data which is impractical to be maintained on online hard disk drives because of capacity issues.

Data migrated from a high performance tier is migrated to the fast mount cache and any other tier according to policies implemented by a data storage manager. The fast mount cache may store migrated data from online hard disk drives and maintains the data by volume. As the fast mount cache capacity fills, or other events trigger a volume change, the fast mount cache selects a volume to be erased. In this manner, the fast mount cache may create space by erasing volumes of data. While data is maintained on the fast mount cache for periods of time soon after it is migrated, the data may be accessed quickly. After the initial period of time has expired, or other storage policies eliminate fast mount cache volumes, the data only exists on tape or other low tier data storage.

FIG. 1 is a block diagram of a tiered data storage system. The data storage system of FIG. 1 includes computing devices 110 and 120, network attached storage systems 130 and 140, high performance tier 150, data storage manager 160, fast mount cache 170, and tape storage or low tier 180. Computing devices 110-120 and NAS 130-140 may serve as a host or source for data being stored by the data storage system comprised of devices 150-180. Computing devices 110 and 120 may create data on 150 to be stored while NAS 130-140 may store data locally for migration to the 150 data storage system. The computing devices and NAS systems may access the data storage system through typical networks such as the internet, and other networks.

High performance tier 150 may provide fast access to store data at higher costs. High performance tier may be utilized with online high performance disc drives. Data storage manager 160 may communicate with high performance tier 150, fast mount cache 170, and tape storage and low tier 190. Data storage manager 160 may implement policies to migrate data from the high performance tier to lower stage tiers and vice versa. Data storage manager 160 may manage migration, implement policies which determine where data should be stored, and manage the fast mount cache 170. Data storage manager may be implemented on a computing device with one or more modules stored in memory that are executable to implement the functionality described herein, and may be implemented separately from storage devices and systems 150-180 or as part of one or more devices and systems 150-180.

Fast mount cache 170 may include an offline storage media that provides very fast volume mount characteristics. A fast mount cache may be used for data with high access rates shortly after creation but which decrease sharply as the data ages. Fast mount cache may be implemented using a massive array of idle discs (MAID) or some other form of offline storage media having a very fast volume mount characteristic. Tape storage or low tier 180 may have low access rates at very low costs. Data storage to tape storage 180 is frequently permanent.

Though the present technology discusses fast mount cache is implemented with MAID in some embodiments, the general concept of the present invention may be applied to any form of tiering, and differing devices within a single tier.

FIG. 2 is a block diagram of a data storage manager. Data storage manager 200 of FIG. 2 may be implemented as one or more computing devices that include software for managing migration and implementing policies. Data storage manager may include fast mount cache manager 220 and data policy engine 230. The fast mount cache manager 220 may include one or more modules which are executable by a processor and stored on memory to manage the fast mount cache. Management of the fast mount cache may determine what volume to write data to, performing fragmentation on the fast mount cache volumes, and erasing volumes from the fast mount cache. Data policy engine 230 may include one or more modules stored on memory and executable by a processor to implement user data policies. The policies may indicate when to migrate data between tiers, when to erase data from a tier, when to retrieve data from a tier and other functions.

In some embodiments, the Fast Mount Cache may eliminate volumes based on policy implemented by the Data Manager. For example, in the high performance tier 150, storage is allocated, consumed, and managed by file or object. At lower tiers 180 and 190, storage may be allocated, consumed, and managed by volume, an aggregation or container of files, or objects. Files and objects may be retrieved individually at the lower tiers. Policies may apply to manage these volumes, to select the right location for a volume or contents thereof into a new volume, eliminating some volumes and accessing objects elsewhere based on performance vs economics. FIG. 3 is a method for migrating data to a fast mount cache. The method of FIG. 3 begins with migrating data from a high performance tier to fast mount cache tier and any other tiers at step 310. The fast mount cache can be implemented by MAID or other fast mount offline storage. When migrating data to fast mount cache, the data is also migrated to any other tiers which the data is intended to be stored at for long or indefinite period of time. In some embodiments, data written to a fast mount cache is written to be contained within a single volume on the fast mount cache.

An event is detected associated with the fast mount cache tier at step 320. The event may trigger a volume of the fast mount cache to be erased, for example according to policies that erase volumes based on active or passive events and are implemented at the data manager. The event may be detection that the storage of the fast mount cache has exceeded a threshold, a period of time expired, or some other event that triggers erasing a volume of data in the cache.

After detecting an event, the fast mount cache may perform defragmentation of one or more volumes at step 330. Defragmentation may be performed using policies based on events. In some embodiments, the defragmentation may be for at least the volume having the oldest data in the fast mount cache, defragging files an old volume into a new volume that were retrieved together, and other events. The defragmentation may help construct new volumes with more consistent write history such that no files are contained only in portions in the volume to be erased.

A volume of data in the fast mount cache is erased at step 340. The volume may be erased as part of a first in first out storage strategy, or alternatively as part of a policy based volume management system. Subsequent data from a high performance tier is migrated to the newly erased volume in the fast mount cache tier at step 350. The erase volume may be used in turn after other volumes are full.

FIG. 4 is a method for retrieving data. The method of FIG. 4 begins with receiving a request for data at step 410. A determination is then made if the data is stored on fast mount cache at step 420. It is determined that the request for data is not stored on a high tier within the data storage system. In determining if the data is located on fast mount cache, the data storage manager may search a record of files stored on the fast mount cache to determine if there is a match. If the data requested is located on the fast mount cache, the data is retrieved from the fast mount cache to the high performance tier at step 430. The data may then be accessed from the high performance tier by the requesting entity.

If the data is not located on the fast mount cache, the data storage manager identifies the next fastest tier from which the requested data is available at step 440. Identifying the next fastest tier may involve querying a list of tier records identifying the tiered order that the data could be provided quickest. For example, the next fastest tier after the fast mount cache would be queried for the file name first. If the file was not located on that record, a record for the next fastest tier would be queried for the file name. Once the next fastest tier was identified, the data is retrieved from that identified tier to the high performance tier at step 450.

FIG. 5 is a block diagram of a computing device used with the present invention. System 500 of FIG. 5 may be implemented in the contexts of the likes of computing devices 110-120, devices comprising NAS 130-140, and data storage manager 160. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 510.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for managing data storage in a multitier data storage system, comprising:
migrating data from a high performance data storage to MAID data storage and tape storage;
detecting an event associated with the MAID data storage; and
erasing the volume of data in the MAID data storage based on a policy associated with the event.

2. The method of claim 1, where in the event is the expiration of a period of time.

3. The method of claim 1, wherein the event is the detection of a threshold available storage space in the MAID data storage.

4. The method of claim 1, further comprising:
defragging one or more volumes of the MAID data storage;
erasing the volume in the MAID data storage based on a second policy after the defragging.

5. The method of claim 1, further comprising:
receiving a request for the data;
retrieving the data from the MAID storage to the high performance data storage if the volume containing the data is still available.

6. The method of claim 1, further comprising:
receiving a request for the data;
retrieving the data from the tape storage to the high performance data storage if the volume containing the data is not available.

7. A computer readable non-transitory storage medium having embodied thereon a program, the program being executable by a processor to perform a method for managing data storage in a multitier data storage system, the method comprising:
migrating data from a high performance data storage to MAID data storage and tape storage;
detecting an event associated with the maid data storage; and
erasing the volume of data in the MAID data storage based on a policy associated with the event.

8. The computer readable non-transitory storage medium of claim 7, where in the event is the expiration of a period of time.

9. The computer readable non-transitory storage medium of claim 1, wherein the event is the detection of a threshold available storage space in the MAID data storage.

10. The computer readable non-transitory storage medium of claim 7, further comprising:
defragging one or more volumes of the MAID data storage;
erasing the volume in the MAID data storage based on a second policy after the defragging.

11. The computer readable non-transitory storage medium of claim 7, further comprising:
receiving a request for the data;
retrieving the data from the MAID storage to the high performance data storage if the volume containing the data is still available.

12. The computer readable non-transitory storage medium of claim 7, further comprising:
receiving a request for the data;
retrieving the data from the tape storage to the high performance data storage if the volume containing the data is not available.

13. A system for managing data storage in a multitier data storage system, the system comprising:
a processor;
a memory;
one or more modules stored in memory and executable by the processor to:
migrate data from a high performance data storage to MAID data storage and tape storage;
detect an event associated with the maid data storage; and
erase the volume of data in the MAID data storage based on a policy associated with the event.

14. The system of claim 13, where in the event is the expiration of a period of time.

15. The system of claim 13, wherein the event is the detection of a threshold available storage space in the MAID data storage.

16. The system of claim 13, further comprising:
defragging one or more volumes of the MAID data storage;
erasing the volume in the MAID data storage based on a second policy after the defragging.

17. The system of claim 13, further comprising:
receiving a request for the data;
retrieving the data from the MAID storage to the high performance data storage if the volume containing the data is still available.

18. The system of claim 13, further comprising:
receiving a request for the data;
retrieving the data from the tape storage to the high performance data storage if the volume containing the data is not available.
